(19) United States
(12) Patent Application Publication
(10) Pub. No.: US 2018/0015745 A1
(43) Pub. Date: Jan. 18, 2018

(54) METHOD FOR CONTROLLING A PRINTING MACHINE AND STOPPING A TRANSPORT DEVICE THEREOF

(71) Applicant: HEIDELBERGER DRUCKMASCHINEN AG, Heidelberg (DE)

(72) Inventors: ARNO JUENGER, WALLDORF (DE); ALBERT MAUL, HEIDELBERG (DE); WOLFGANG DOLZ, HEIDELBERG (DE); PETER THOMA, MANNHEIM (DE); THOMAS SCHMIDT, HEIDELBERG (DE)

(21) Appl. No.: 15/649,686

(22) Filed: Jul. 14, 2017

(30) Foreign Application Priority Data
Jul. 14, 2016 (DE) 102016212865.5

(51) Int. Cl. B41J 13/00

(52) U.S. Cl. CPC B41J 13/0009

(57) ABSTRACT

A method for controlling a printing machine including a revolving transport device for transporting a substrate, includes continuously scanning the surface of the transport device using a detection device, evaluating measured results to find defects on the surface, saving the defects in a data memory and outputting information on the defects. The method advantageously provides an operator with targeted information on defect type, defect location and defect frequency and thus allows a targeted elimination of defects, which may increase the overall productivity of the printing machine.

### CROSS-REFERENCE TO RELATED APPLICATION

This application claims the priority, under 35 U.S.C. §119, of German Patent Application DE 10 2016 212 865.5, filed Jul. 14, 2016; the prior application is herewith incorporated by reference in its entirety.

### BACKGROUND OF THE INVENTION

### Field of the Invention

The invention relates to a method for controlling a printing machine including a revolving transport device for transporting a substrate which is to be printed on or which has already been printed on.

### Description of the Related Art

The use of digital printing machines has become known in the art for printing small runs or personalized prints on sheets of paper, board, and cardboard. If inkjet heads are used to print on the sheets, a respective sheet is passed underneath the inkjet heads at a minimum distance by using a transport system. Known transport systems include revolving transport belts, for instance constructed as suction belts, and rotating cylinders, referred to as jetting cylinders, or revolving tablets as disclosed, for instance, in U.S. Pat. No. 8,579,286 B2.

Machine concepts that use cylinders as described, for instance, in U.S. Patent Application Publication US 2009/0284561 A1 include multiple inkjet print heads disposed at a radial distance above a jetting cylinder to print on sheets that are moved past at a short distance from the print heads. A jetting cylinder may simultaneously hold multiple sheets by suction and transport them. An important aspect in attaining high-quality prints and avoiding damage to the print heads is to ensure that a respective sheet rests securely on the jetting cylinder.

In addition, ways to monitor sheet travel and detect defective sheets or sheets that are not held securely have become known. In order to prevent damage to the highly sensitive printing nozzles of an inkjet head caused for instance by raised corners, edges, or creases, the printing machine is generally stopped and the defective sheet is removed.

Such a printing machine is disclosed in U.S. Patent Application Publication US 2013/0307893 A1. When a sensor disposed upstream of the inkjet heads detects a defective sheet, not only is the machine stopped but also the inkjet print heads are lifted and moved into a retracted position. The machine operator may then remove the defective sheets without difficulty.

If sheets that are not obviously defective, e.g. have a visible crease or dog-ear, are present on the printing cylinder, it is difficult for an operator of the prior art machines to eliminate a defect because he or she does not realize that the defect is present.

Another problem is that an operator actually only realizes defects that exceed a specific intervention value because the machine only stops if the defect exceeds a defined threshold. If repeated defects below that threshold occur, the operator will not notice them at all. Such repeated defects may for instance be lint on the gripper, bent grippers, or pre-coat residue on the sheet. Thus, an early intervention to prevent a future undesired machine stop, collision, or damage is not possible.

### SUMMARY OF THE INVENTION

It is accordingly an object of the invention to provide a method for controlling a printing machine and stopping a transport device thereof, which overcomes the hereinafore-mentioned disadvantages of the heretofore-known methods of this general type, which detects causes of defects at an early point, which allows the defects to be more easily eliminated and which is also intended to allow an evaluation of repetitive errors.

With the foregoing and other objects in view there is provided, in accordance with the invention, a method for controlling a printing machine having a revolving transport device for transporting a substrate to be printed on or that has already been printed on. The revolving transport device may be a cylinder, in particular a so-called jetting cylinder, or a transport belt. The method of the invention comprises the following steps:

In a first step, the surface of the transport device is continuously scanned by a detection device that may include a sensor, multiple sensors, or a camera. Scanning the surface means scanning the support surfaces of the transport device and the substrate resting on the support surfaces as well as detecting grippers that may be present on the transport device.

In a second step, measured results are evaluated for defects or rather locations of defects on the surface of the transport device. Such defects may for instance include defective grippers, lint on the grippers, pre-coat residue, creases, or warped substrates, etc.

The next step is to save the defects including defect type and defect location in a data memory of a machine control unit. If a defect is detected a number of times, e.g. at every revolution of the transport device, the frequency of the defect is likewise documented in the data memory.

In a last step, information on the defects is output to an operator of the machine as a warning related to the detected defects.

Such a method advantageously allows the operator of the machine to receive targeted information on defect types, defect location, and defect frequency and thus to eliminate defects in a targeted way. This allows the overall productivity of the machine to be increased.

Information on the defects, namely on defect type, defect location, and defect frequency may be indicated on a screen or display and/or by switching on a warning light and/or by outputting an acoustic signal.

It is particularly advantageous if an evaluation of repeated defects is additionally made during the evaluation of the measured results. This means that the evaluation routine of the machine control unit identifies repetitive defects as such, which are also referred to as systematic defects, because all defects saved in the data memory are examined in the course of the evaluation. This embodiment of the method is of particular advantage because it allows even smaller defects to be identified at an early point. If ignored, such smaller defects might later on have a more serious effect on the productivity of the machine, for instance because of damage to individual components of the machine, in particular the grippers.

An advantageous further development of the method of the invention includes the following additional step: if a repetitive defect has been detected, in addition to informing the operator of the machine, the transport device is stopped in order for the repeated defect to be immediately eliminated. The stop may occur in an automated way or in a controlled way at a defined point in time, e.g. when a job or part of a job is finished. Alternatively, the stop may occur after authorization by the machine operator.

It is particularly advantageous if the stopping of the transport device occurs at a specific machine angle in which the defect location is visible and accessible to an operator of the machine, allowing the defect to be quickly and easily eliminated. In other words, the stopping of the transport device occurs in an angle-controlled way. For instance, if a repeated defect was found on the gripper of a specific gripper bar, the transport device is stopped in such a way that the defective gripper is in a position in which it is easily and ergonomically accessible to the operator. This makes it easy for the machine operator to replace or repair the gripper. In accordance with a preferred embodiment, the machine angle that is selected for an angle-controlled stop is in the region of an access opening of the printing machine. The access opening may be a flap, window, or blind.

In a possible further development of the method for controlling a printing machine, an additional step is to highlight the defect location of the defect by spot illumination, e.g. by using a laser or laser pointer, or by using LEDs disposed across the width of the machine. In this way, the location of a defect may be communicated to the operator with great accuracy. When combined with outputting information on the defects, this allows a particularly adequate and quick elimination of the defect.

As far as it makes sense from a technical point of view, combinations of the features of the invention described above and the advantageous further developments of the invention described above also form advantageous further developments of the invention.

Other features which are considered as characteristic for the invention are set forth in the appended claims. Further advantages and embodiments of the invention that are advantageous in structural and functional terms will become apparent from the dependent claims and from the description of exemplary embodiments with reference to the appended figures.

Although the invention is illustrated and described herein as embodied in a method for controlling a printing machine and stopping a transport device thereof, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a digital printing machine having a sensor system;

FIG. 2 is a more detailed longitudinal-sectional view of the digital printing machine of FIG. 1; and

FIG. 3 is a view similar to FIG. 2 of an alternative to the embodiment of FIG. 2.

### DETAILED DESCRIPTION OF THE INVENTION

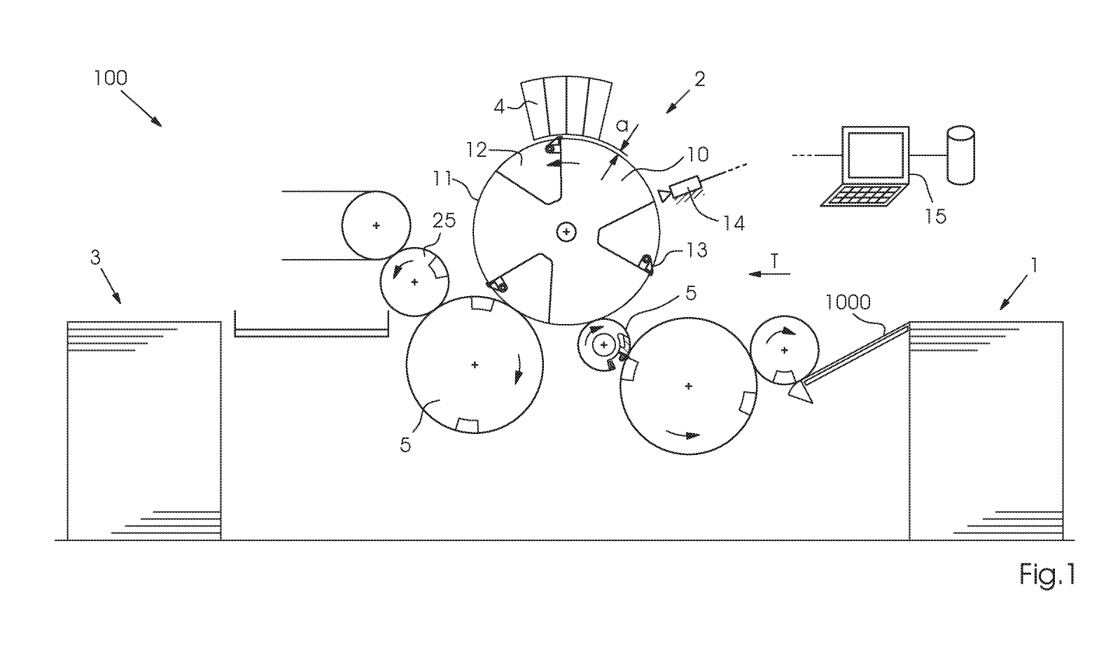

Referring now in detail to the figures of the drawings, in which elements and components that correspond to one another have the same reference symbol and which are not drawn to scale, and first, particularly, to FIG. 1 thereof, there is seen a sheet-fed printing machine 100 constructed as a digital printing machine. A respective sheet 1000 coming from a feeder 1 is transported through a printing unit 2 to a delivery 3 in a direction of transport T. The respective sheet 1000 is transported mostly on cylinders, namely transfer cylinders 5 and a printing cylinder 10. Inkjet heads 4 disposed at a distance a above the printing cylinder 10 print on a sheet 1000 that is transported past at a short distance by the printing cylinder 10. Thus, the printing cylinder 10 is also referred to as a jetting cylinder or a transport device.

In the illustrated embodiment, the printing cylinder 10 has three sheet-holding regions or sheet-supporting surfaces 11 separated from one another by respective gaps 12. The sheets 1000 are held on the sheet-holding regions 11 by grippers 13.

A machine control unit 15, including a user interface and a memory, is provided to control the printing machine 100. A sensor system 14 for continuously monitoring the sheets 1000, the surface of the jetting cylinder 10 and the grippers 13 of the jetting cylinder 10, is disposed upstream of the inkjet heads 4 as viewed in the direction of transport T. For this purpose, the sensor system 14 is disposed in the path of sheet travel. The sensor system 14 may in particular monitor the traveling of the sheets, i.e. a printing material thickness d indicating how far the sheets 1000 protrude above the sheet-holding regions 11. In this way, creases, dog-ears, folds, waves, and sheets 1000 that are held insufficiently or badly may be detected. Surface contamination of the jetting cylinder 10 or defective or bent grippers 13 may likewise be detected. A data transmission connection is provided between the sensor system 14 and the machine control unit 15, which also includes sensor control.

The sensor system 14 is to be disposed sufficiently far upstream of the inkjet heads 4 to ensure that a collision between sheets 1000 and inkjet heads 4 may be avoided, for instance by stopping the machine 100, lifting the inkjet heads 4, or diverting the defective sheet 1000 (not illustrated), even if a defect occurs at the trailing sheet edge of a sheet 1000.

A removal drum 25 for removing defective sheets, e.g. sheets 1000 with an incomplete print, is disposed downstream of the jetting cylinder 10.

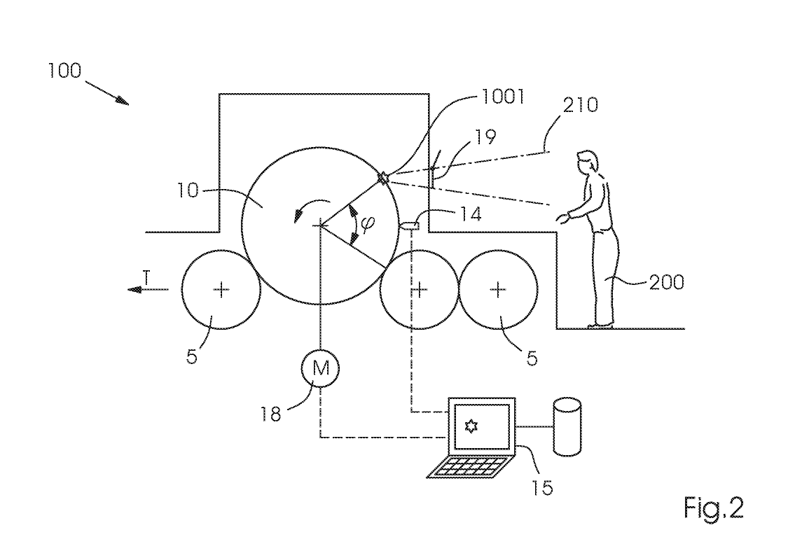

FIG. 2 illustrates a section of the printing machine 100 shown in FIG. 1. The housing of the printing machine 100 includes an access opening 19, which is for instance constructed as a flap that may be opened and closed. While in an ergonomically favorable position, a machine operator 200 has a field of vision 210 that extends through the access opening 19 and as far as the printing cylinder 10.

A detection device 14, which may include sensors or cameras, continuously monitors the surface of the printing cylinder 10. A machine control unit 15 evaluates measured results. If defects are detected, they are saved in a data memory connected to the machine control unit 15. The machine control unit 15 examines the defects saved in the data memory to find repetitive defects, also referred to as systematic defects, by evaluating defect type, defect location, and defect frequency. If a defect 1001 or a repetitive defect has been detected, the relevant information is output to the machine operator 200 on a screen or display of the machine control unit 15. In addition, the printing cylinder 10 may be stopped in the following angle-controlled way: since the defect location is documented in the machine control unit 15, a drive motor 18 of the printing cylinder 10 may be actuated in such a way that the printing cylinder 10 is stopped at a machine angle φ, positioning a defect 1001 precisely in the field of vision 210 of the machine operator 200 and consequently in the region in which the machine operator 200 may intervene through the access opening. For this purpose, there is a data transmission connection between the drive motor 18 and the machine control unit 15. Based on the defect information indicated on the display of the control unit 15, the machine operator 200 may effect a quick and simple elimination of the defect 1001.

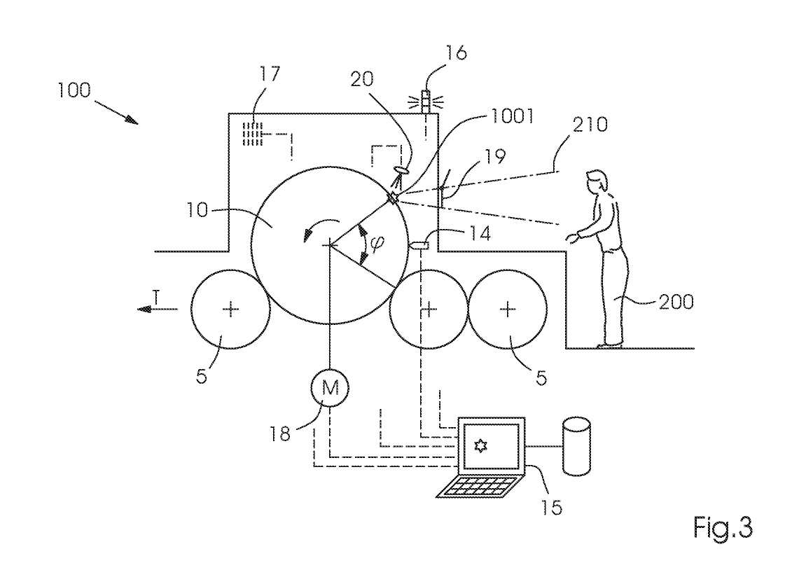

As shown in FIG. 3, the printing machine 100 may additionally be equipped with a loudspeaker or a signal horn 17 as well as a warning light 16 to alert the machine operator 200 to a defect 1001 and the need for intervention. A data transmission connection is provided between these components and the machine control unit 15.

In order to be able to accurately indicate the defect location of the defect 1001 to the machine operator 200, an illumination device 20 that is actuated by the machine control unit to accurately illuminate the defect location may be provided in the printing machine 100. The illumination device 20 may be used to mark the location of the defect 1001 by using spot illumination.

1. A method for controlling a printing machine including a revolving transport device for transporting a substrate to be printed on or already having been printed on, the method comprising the following steps:
a) using a detection device for continuously scanning a surface of the transport device;
b) evaluating measured results from the detection device to find defects on the surface of the transport device;
c) using a data memory to save the defects and to additionally evaluate repeated defects; and
d) outputting information about the defects.

2. The method for controlling a printing machine according to claim 1, which further comprises carrying out step d) by at least one of displaying information on a display or switching on a warning light or outputting an acoustic signal.

3. The method for controlling a printing machine according to claim 1, which further comprises carrying out an additional step e) of stopping the transport device if a repeated defect occurs.

4. The method for controlling a printing machine according to claim 3, which further comprises carrying out the additional step e) as a further step e') of stopping the transport device at a machine angle permitting a defect location of the defect to be visible and accessible to a machine operator.

5. The method for controlling a printing machine according to claim 4, which further comprises setting the machine angle in a region of an access opening of the printing machine.

6. The method for controlling a printing machine according to claim 4, which further comprises carrying out an additional step f) of marking the location of the defect by using spot illumination.

7. The method for controlling a printing machine according to claim 1, which further comprises carrying out step a) of scanning the surface of the transport device by scanning support surfaces of the transport device and scanning the substrate resting on the support surfaces.
